(19) United States
(12) Patent Application Publication
(10) Pub. No.: US 2026/0056967 A1
(43) Pub. Date: Feb. 26, 2026

(54) SYSTEM AND METHOD FOR OPERATING AN ANALYTICS PLATFORM

(71) Applicant: GUPSHUP TECHNOLOGY INDIA PRIVATE LIMITED, Maharashtra (IN)

(72) Inventor: Nirmesh Mehta, Maharashtra, IN (US)

(21) Appl. No.: 19/307,304

(22) Filed: Aug. 22, 2025

(30) Foreign Application Priority Data
Aug. 24, 2024 (IN) 202421064053

(51) Int. Cl. G06F 16/25; G06F 16/245

(52) U.S. Cl. CPC G06F 16/254; G06F 16/245

(57) ABSTRACT

The present invention discloses an analytics platform (102). In one embodiment, the analytics platform (102) allows multiple module owners to define their individual Extract, Transform, and Load (ETL) pipelines, processes and stores data as per client requirements, an provides an unified interface at a query level. In one embodiment, an application developer (112) may configure the analytics platform (102) to build an analytics pipeline, and configures an application (104) to work with the analytics platform (102). Further, the application (104) is configured to send data to the analytics platform (102) for ingestion. Further, queries are created upon generation of data transformation logic. Furthermore, widgets associated with the queries are determined to generate reports and dashboards. The generated reports, from the analytics platform (102), are further used by an analyst (110) for business use cases.

### CROSS REFERENCE TO RELATED APPLICATION AND PRIORITY

The present invention claims priority from Indian Patent Application number 202421064053 filed on date 24th August 2024.

### FIELD OF THE INVENTION

The present invention relates to the field of a system and a method for operating an analytics platform. More particularly, the invention relates to an analytics platform that allows various module owners to define Extract, Transform, and Load (ETL) pipelines as per client requirements.

### BACKGROUND OF THE INVENTION

Generally, in SaaS domains, where a number of modules need to work together to provide an end to end user experience (like Enterprise resource planning (ERP), Customer relationship management (CRM), messaging experiences, and the like), analytics is a hard problem to solve. Since a lot of data is often Personally Identifiable Information (PII), merging all data into a common schema leads to a lot of compliance issues. Further, often the data security requirements are specific to clients. At the same time, having separate analytics solution in each module leads to maintenance and consistency issues. Thus, there is a need of flexible platforms that can be reused based on client requirements.

Generally, organization may need plurality of analytics tools to perform analysis of the data flowing within an organization. Generally, the amount of data flowing within an organizations are in heavy storage (in GBs or TBs). User cannot manually manage the heavy storage data. Hence, the organization needs to develop a system that receive the data and analyzes it to generate reports, graphs, tables, charts, etc. Deployment of such system or tools on premise is costly and requires specialized skills.

Hence to overcome the aforesaid drawbacks an analytics platform as a service-provider is required.

### OBJECTS OF THE INVENTION

Main object of the present disclosure is to allow various module owners to define their individual Extract, Transform, and Load (ETL) pipelines, process and store data as per client requirements and provide a unified interface at the query level.

Another object of the present disclosure is to configure an analytics platform to build an analytics pipeline and configure an application to work with the analytics platform.

Yet another objective of the present disclosure is that the analytics platform enables authentication and authorization seamlessly.

Yet another objective of the present disclosure is that the analytics platform monitors the load and uses queries to generate a load test profile automatically, and uses the same to load test and certify changes to an analytics code.

Yet another objective of the present disclosure is that the analytics platform provides a library of standard data models together with associated standard transformation use cases as well as storage formats and mechanisms.

Yet another objective of the present disclosure is that the analytics platform uses the load test to automatically decide on an optimum technology to use for a reporting database.

Yet another objective of the present disclosure is that the analytics platform provides a library of the widget, charts, graphs, and the like.

### SUMMARY OF THE INVENTION

Before the present an analytics platform is described, it is to be understood that this application is not limited to a particular the analytics platform as there may be multiple possible embodiments, which are not expressly illustrated in the present disclosures. It is also to be understood that the terminology used in the description is for the purpose of describing the particular implementations, versions, or embodiments only, and is not intended to limit the scope of the present application. This summary is provided to introduce aspects related to the analytics platform. This summary is not intended to identify essential features of the claimed subject matter nor is it intended for use in determining or limiting the scope of the claimed subject matter.

The present invention relates to a system and method for providing an analytics platform capable of processing multiple user requests, executing ETL pipelines, and generating secure, real-time analytics reports. The invention is designed to address the need for a flexible, modular, and developer-configurable Extract-Transform-Load (ETL) environment that supports high data integrity, scalability, and integration with external applications.

The present invention discloses an analytics platform. In one embodiment, the analytics platform allows multiple module owners to define their individual Extract, Transform, and Load (ETL) pipelines, processes and stores data as per client requirements, an provides an unified interface at a query level. In one embodiment, an application developer may configure the analytics platform to build an analytics pipeline, and configures an application to work with the platform. Further, the application is configured to send data to the analytics platform for ingestion. Further, queries are created upon generation of data transformation logic. Furthermore, widgets associated with the queries are determined to generate reports and dashboards. The generated reports, from the analytics platform, are further used by an analyst for business use cases.

The present invention discloses a system a system for providing an analytics platform, the system comprising a user device configured to receive a plurality of user requests, wherein each user request comprises a query and an input data, a reporting database operably coupled to a processor, the reporting database configured to store the query and the input data, a processor coupled with a memory configured for storing the reporting database, a plurality of modules executable by the processor. The plurality of modules comprising an ingestion module configured to receive the plurality of user requests from the user device or an external application through one or more defined application programming interfaces (APIs). An Extract-Transform-Load (ETL) module configured to generate an Extract-Transform-Load (ETL) pipeline for each user request the ETL pipeline comprising a plurality of pipeline nodes connected according to configuration data defined through a developer interface and perform a plurality of a processing operations on the input data at each of the pipeline nodes, the processing operation comprising at least one of a transformation, summarization, aggregation, slicing, and augmentation, configure each pipeline node to receive data from one or more upstream nodes, process that data, and provide processed data to one or more downstream nodes, store, at one or more designated nodes, the processed data in the reporting database, and automatically generate and execute the ETL pipeline based on a high-level analytical requirements of the user request, a plurality of widget libraries configured to query the reporting database, and retrieve processed data associated with the plurality of user requests, and an engine, executable by the processor, configured to generate graphical and tabular reports by invoking widgets from the widget libraries, the reports being based on the processed data stored in the reporting database, wherein a separate ETL pipeline is instantiated and executed for each user request thereby providing data segregation and secure operation.

In another embodiment, the ingestion module receives input data from the user device or external application and forwards said input data to the ETL module, the ETL module processes and stores the data in the reporting database, the widget libraries retrieve the processed data from the reporting database, and the engine generates reports by invoking the widget libraries.

In another embodiment, the developer interface is configured to provide a plurality of pre-defined ETL pipeline templates, wherein the plurality of pre-defined ETL pipeline templates is selected and modified by a developer based on the user request.

In another embodiment, the ingestion module is configured to provide real-time data ingestion based on the nature of the user request.

In another embodiment, each pipeline node in the ETL module is associated with a specific operation defined by configuration data, the operation comprising at least one of a data transformation, a data validation, a data join, or a data enrichment step.

In another embodiment, the pipeline nodes are dynamically instantiated based on the analytical requirements of the user request, such that only the required nodes are activated within the ETL pipeline.

In another embodiment, each pipeline node is assigned a unique identifier to enable tracking of data flow and logging of results at each stage of the ETL pipeline.

In another embodiment, one or more pipeline nodes are designated as storage nodes configured to commit processed data to the reporting database, while other pipeline nodes serve as intermediate nodes configured to pass data further downstream for additional processing without storing results.

In another embodiment, each pipeline node is further configured with metadata defining node type, processing method, and expected input and output schema.

In another embodiment, each ETL pipeline instantiated for a user request is executed in an isolated runtime environment selected from at least one of: a separate execution thread, a containerized process, or a virtual machine instance, thereby preventing data leakage or interference between multiple user requests.

In another embodiment, the developer interface is configured to integrate the widget into a user interface of the external application or an internal dashboard.

In another embodiment, the widget is configured to retrieve processed data from the reporting database in response to a real-time user request, and to apply formatting logic to the retrieved data prior to generating the graphical and tabular reports.

In another embodiment, the graphical and tabular reports are configured to be embedded within a user interface of the external application via pre-generated code including HTML, JavaScript, or Cascading Style Sheets (CSS).

In another embodiment, the developer interface is configured to package the ingestion configuration, ETL pipeline, and widget logic into a deployable code module for execution by the processor.

In another embodiment, the transformation processing step is configured to convert input data format into normalized values and derive new data fields using transformation logic.

In another embodiment, the summarization processing step is configured to generate statistical summaries of input data, the statistical summaries comprising at least one of: a count, average, minimum, and maximum values over a defined time window or group.

In another embodiment, the aggregation processing step is configured to combine multiple records into a single output record using an aggregation rule, the aggregation rule being defined through the developer interface.

In another embodiment, the slicing processing step is configured to filter and separate incoming data based on predefined conditions, the predefined conditions being selected from at least one of: date, category, or user segment, and defined through the developer interface.

In another embodiment, the developer interface is configured to define the connection between each pipeline node and to assign data processing logic to each node.

In another embodiment, the ETL Module is configured to simultaneously execute a plurality of pipeline nodes in the absence of a direct data dependency between said pipeline nodes, thereby improving processing efficiency.

In another embodiment, a method for operating an analytics platform, the method comprising receiving, at an ingestion module, a plurality of user requests from a user device or an external application, each user request comprising a query and input data, the user requests being received through one or more defined application programming interfaces (APIs), generating, by an Extract-Transform-Load (ETL) module, an ETL pipeline for each user request, the ETL pipeline comprising a plurality of pipeline nodes connected according to configuration data defined using a developer interface, executing processing operations on the input data at each of the plurality of pipeline nodes, each processing operation comprising at least one of transformation, summarization, aggregation, slicing, or augmentation, configuring each pipeline node to receive data from one or more upstream nodes, process that data, and provide processed data to one or more downstream nodes, storing, at one or more designated pipeline nodes, processed data in a reporting database, automatically generating and executing the ETL pipeline based on high-level analytical requirements defined in the user request, retrieving, using one or more widget libraries, the processed data associated with the plurality of user requests from the reporting database, and generating, by an engine, graphical and/or tabular reports based on the processed data and by invoking widgets from the widget libraries, wherein a separate ETL pipeline is instantiated and executed for each user request, thereby providing data segregation and secure operation.

### BRIEF DESCRIPTION OF DRAWINGS

The foregoing summary, as well as the following detailed description of embodiments, is better understood when read in conjunction with the appended drawings. For the purpose of illustrating the disclosure, there is shown in the present document example constructions of the disclosure. The detailed description is described with reference to the following accompanying figures.

FIG. 1(a) illustrates a block diagram of a network implementation of a system for providing an analytics platform, in accordance with an embodiment of the present subject matter.

FIG. 1(b) illustrates a block diagram of the system, in accordance with an embodiment of the present subject matter.

FIG. 1(c) illustrates a block diagram of an analytics platform in a preferred embodiment of the present invention.

FIG. 2 illustrates a flow chart showing a method for operating the analytics platform, in accordance with an embodiment of the present subject matter.

The figure depicts various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “comprising”, “having”, and “including,” and other forms thereof, are intended to be equivalent in meaning and be open ended in that an item or items following any one of these words are not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any devices and methods similar or equivalent to those described herein can be used in the practice or testing of embodiments of the present disclosure, the exemplary, devices and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

Following is a list of elements and reference numerals used to explain various embodiments of the present subject matter.

| Reference Numeral | Element Description |
|---|---|
| 100 | System |
| 101 | User device/interface |
| 102 | Analytics Platform |
| 103 | Memory |
| 104 | Application |
| 105 | Network |
| 106 | Backend Server |
| 107 | Processor |
| 108 | Frontend Server |
| 110 | Analyst |
| 112 | Developer |
| 114 | Ingestion Module |
| 116 | ETL Module |
| 118 | Reporting Database (DB) |
| 120 | Developer Tool |
| 122 | Widget Library |
| 200 | Method |

In an existing technology, in SaaS domains, where a number of modules need to work together to provide an end to end user experience (like Enterprise resource planning (ERP), Customer relationship management (CRM), messaging experiences, and the like), analytics is a hard problem to solve. Since a lot of data is often Personally Identifiable Information (PII), merging all data into a common schema leads to a lot of compliance issues. Further, often the data security requirements are specific to clients. At the same time, having separate analytics solution in each module leads to maintenance and consistency issues.

In one embodiment, an ideal solution is to provide a mechanism to maximize code and engineering effort reuse while allowing for flexibility both to module owners for solving their business requirements and to clients for data security.

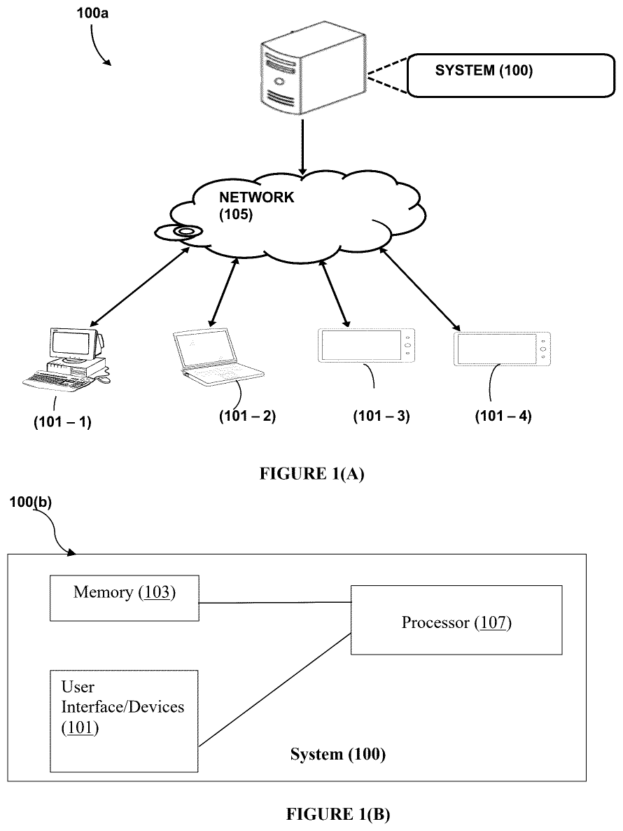

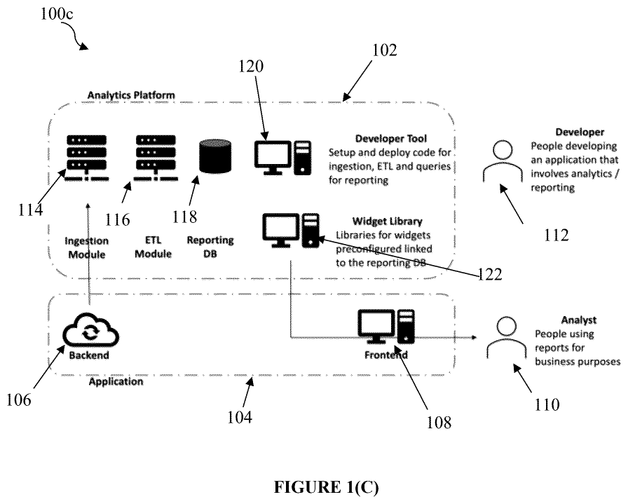

Referring now to FIG. 1(a), a network implementation (100a) of a system (100) for providing an analytics platform (102) is illustrated, in accordance with an embodiment of the present subject matter.

Although the present disclosure may be explained considering that the system (100) may be implemented on the server, it may be understood that the system (100) may be implemented in a variety of computing systems, such as a laptop computer, a desktop computer, a notebook, a workstation, a mainframe computer, a server, a network server, a cloud-based computing environment. It will be understood that the system (100) may be accessed by multiple users through one or more user devices (101-1), (101-2) . . . (101-N), collectively referred to as user 101, hereinafter, or applications residing on the user devices (101).

In one implementation, the system (100) may comprise the cloud-based computing environment in which a user may operate individual computing systems configured to execute remotely located applications. Examples of the user devices (101) may include, but are not limited to, an IoT device, IoT gateway, portable computer, a personal digital assistant, a handheld device, and a workstation. The user devices (101) are communicatively coupled to the system (100) through a network (105). In an embodiment, the analytics platform (102) of the system is connected to a backend server (106) and frontend server (108) (as shown in FIG. 1(c)) of the user or analyst's (110) system. Further, the user device (101) may be used by a user to provide an user request. In one embodiment, the user request may comprises query and an input data. In one embodiment, the user may be an analyst (110), and the like. In an embodiment, the system (100) may be referred to as the analytics platform (102).

In one implementation, the network (105) may be a wireless network, a wired network or a combination thereof. The network (105) can be implemented as one of the different types of networks, such as intranet, local area network (LAN), wide area network (WAN), the internet, and the like. The network (105) may either be a dedicated network or a shared network. The shared network represents an association of the different types of networks that use a variety of protocols, for example, Hypertext Transfer Protocol (HTTP), Hypertext Transfer Protocol Secure (HTTPS), Transmission Control Protocol/Internet Protocol (TCP/IP), Wireless Application Protocol (WAP), and the like, to communicate with one another. Further the network (105) may include a variety of network devices, including routers, bridges, servers, computing devices, storage devices, and the like.

Referring now to FIG. 1(b) (100b), the system (100) is illustrated in accordance with an embodiment of the present subject matter. In one embodiment, the system (100) may include, a user interface/devices (101), a memory (103), and at least one processor (107). The at least one processor (107) may be implemented as one or more microprocessors, microcomputers, microcontrollers, digital signal processors, central processing units, state machines, logic circuitries, and/or any devices that manipulate signals based on operational instructions. Among other capabilities, the at least one processor (107) is configured to fetch and execute computer-readable instructions stored in the memory (103). The user device (101) is configured to receive a plurality of user requests. Each user request comprises a query and an input data.

Referring to FIG. 1(c), a block diagram 100 of an analytics platform (102) is illustrated, in accordance with an embodiment of the present invention. In one embodiment, the block diagram 100 shows an analytics platform (102), an application (104), an analyst (110), and a developer 112.

In one embodiment, the analytics platform (102) further comprises an ingestion module (114), an Extract-Transform-Load (ETL) module (116), a reporting database (DB) (118), a developer (120), and a widget library (122). The reporting database (118) is operably coupled to the user device (101). The reporting database (118) is configured to store the query and the input data. The processor (107) coupled with a memory (103) for storing the reporting database (118). Further, the ingestion module (114) and the ETL Module (116) are executable by the processor (107).

The developer (120) may be utilized for setup and deploying code for ingestion, an extract, transform, and load (ETL) process, and queries for reporting. The developer (120) may be used by the developer 112. In one embodiment, the developer 112 may be people developing the application (104) that involves analytics and reporting. The developer 112 may be accessing the developer (120) via a device such as a mobile phone, a laptop, and the like. In one embodiment, the widget library (122) may correspond to libraries for widgets preconfigured and linked to the reporting DB 118.

In one embodiment, the application (104) may correspond to a website or an app downloadable from an application store. The application (104) may comprise a backend server 106 and a frontend server 108. The widget library (122) may be accessed by the analyst (110) via the frontend server 108. The analyst (110) may be people using reports for business purpose. The analyst (110) may be using a device such as a mobile phone, a laptop, and the like, to access the application (104) and the analytics platform (102).

In one embodiment, the developer 112 may configure the analytics platform (102) to build an analytics pipeline and configure the application (104) to work with the analytics platform (102). Further, the application (104) may be configured to send data to the analytics platform (102) for ingestion via the ingestion module (114). Furthermore, the analyst (110) may be using reports from the analytics platform (102) for business purpose. The analytics platform (102) processes an ingested data to generate the reports.

In one embodiment, the system (100) comprises the user device (101) configured to receive a plurality of user requests, each user request including a query and corresponding input data. The user device (101) is operably coupled to a reporting database (118). The reporting database (118) stores both the query and the input data for subsequent processing. The system (100) further comprises a processor (107) coupled to a memory (103) for storing the reporting database (118).

The processor (107) executes a plurality of modules, including an ingestion module (114), an ETL Module (116), and a widget library (122). The ingestion module (114) is configured to receive the plurality of user requests from an external application or the user device (101) using a plurality of injection hooks or API. The ingestion module (114) supports both real-time ingestion and batch-mode ingestion, enabling the system (100) to handle time-sensitive analytics requests as well as bulk data uploads.

The ETL Module (116) is configured to generate an ETL pipeline for each user request using a developer (120). Each ETL pipeline comprises a plurality of pipeline nodes, with each node representing a specific data processing stage. The developer (120) enables a developer to define data processing logic, specify injection hooks or API, and configure node-to-node connections. In certain embodiments, the developer (120) provides a set of pre-defined ETL pipeline templates that can be selected and modified based on the specific analytics requirements of a user request.

Each pipeline node is configured to perform one or more processing steps on the input data, including transformation, summarization, aggregation, slicing, and augmentation.

In an embodiment, the transformation steps may include converting data formats into normalized values and deriving new data fields using transformation logic.

In another embodiment, the summarization steps may include generating statistical summaries such as count, average, minimum, and maximum over a defined time window or grouped dataset.

In another embodiment, the aggregation steps may combine multiple records into a single output record based on aggregation rules defined in the developer (120).

In another embodiment, the slicing steps may filter and separate incoming data according to predefined conditions, such as date, category, or user segment.

In another embodiment, the each pipeline node may further maintain and update an internal state during data processing to support stateful analytics.

As per one illustrative example, the system (100) may receive a user request. The user request comprising the query and input data. Further, the input dataset contains user records in the following format:

| UserID | First Name | Gender | Monthly Income |
|---|---|---|---|
| 1 | Amit | Male | 10000 |
| 2 | Vijay | m | 25000 |
| 3 | Amrita | f | 20000 |
| 4 | Priya | FEMALE | 40000 |

Further, the system (100) is configured to perform Transformation processing steps on the received data by using ingestion hooks or API's. The user may provide a query to convert the genders to 0 for m/male (ignore case) and 1 for f/female (ignore case). Upon ingestion, the developer (120) may define a simple transformation hook configured to normalize gender values. In the example, the transformation converts gender values to numerical representations, where any value equivalent to “m” or “male” (case-insensitive) is converted to 0, and any value equivalent to “f” or “female” (case-insensitive) is converted to 1. The output of this transformation is as follows:

| UserID | First Name | Gender | Monthly Income |
|---|---|---|---|
| 1 | Amit | 0 | 10000 |
| 2 | Vijay | 0 | 25000 |
| 3 | Amrita | 1 | 20000 |
| 4 | Priya | 1 | 40000 |

Further, the system (100) is configured to perform the summarization processing step on the processed output data of the transformation step. Further, the user or analyst (110) may provide a query to drop the name column from the processed output data of the transformation step. The summarization processing step is configured to drop non-essential columns. In the example, the step may remove the “First Name” field. The remaining dataset retains the original gender entries from the raw data (i.e., without the transformation hook applied) to preserve reporting flexibility. The output of the summarization is as follows:

| UserID | Gender | Monthly Income |
|---|---|---|
| 1 | Male | 10000 |
| 2 | m | 25000 |
| 3 | f | 20000 |
| 4 | FEMALE | 40000 |

Further, the system (100) is configured to perform the aggregation processing step on the processed output data of the summarization processing step. Further, the user may provide a query of aggregate monthly income by gender (after the simple transformation). The aggregation processing step may combine multiple records to produce a single output record per category. As per example, aggregation is performed after the gender transformation step, summing the monthly income values for each gender code. The aggregated result is as follows:

| Gender | Sum of Monthly Income |
|---|---|
| 0 | 35000 |
| 1 | 60000 |

Further, the system (100) is configured to perform the slicing processing step on the processed output data of the aggregation processing step. Further, the user may provide a query to select data of females only (after the simple transformation). The slicing processing step may filter the dataset to only include records meeting a predefined condition. In this example, the dataset is filtered to include only records where the gender code equals 1 (female). The output of the slicing processing step is as follows:

| UserID | First Name | Gender | Monthly Income |
|---|---|---|---|
| 3 | Amrita | 1 | 20000 |
| 4 | Priya | 1 | 40000 |

Further, the system (100) is configured to perform the augmentation processing step on the processed output data of the slicing processing step. Further, the user may provide a query to add the email column using the following separate data. The augmentation processing step may add new data columns to the existing dataset by joining with an external dataset. In this example, an additional dataset containing user emails is joined with the original dataset based on the UserID field. Further, user or analyst (110) may provide additional data as input through the user device (101):

| UserID | Email |
|---|---|
| 1 | amit@gmail.com |
| 2 | vijay@gmail.com |
| 4 | priya@gmail.com |
| 5 | pranab@gmail.com |

After augmentation processing step, the resulting dataset is as follows:

| UserID | Gender | Monthly Income | Email |
|---|---|---|---|
| 1 | Male | 10000 | amit@gmail.com |
| 2 | m | 25000 | vijay@gmail.com |
| 3 | f | 20000 | |
| 4 | FEMALE | 40000 | priya@gmail.com |

As per illustrated example, the modular nature of the ETL pipeline is illustrated. The ETL pipeline may perform sequential processing steps including transformation, summarization, aggregation, slicing, and augmentation. The ETL pipeline may select and apply plurality of the processing steps independently or in combination as per the user or analyst (110) requirement. The system (100) may create multiple ETL pipeline for multiple user request. This flexibility enables the system (100) to address a wide variety of analytics requirements while ensuring that intermediate outputs may be stored, reused, or further refined in subsequent pipeline nodes. The reporting database (118) may store each result or output of each processing steps.

The ETL Module (116) is designed to automatically generate and execute the ETL pipeline based on high-level analytical requirements defined in the user request. Where possible, the ETL Module (116) executes multiple pipeline nodes in parallel if no direct data dependency exists between them, thereby improving processing efficiency. Each pipeline node may receive input from one or more upstream nodes, transmit processed data to one or more downstream nodes, and store intermediate or final results in the reporting database (118).

The system comprises an engine which is executable by the processor to generate graphical and tabular reports by invoking widgets from the widget libraries (122). In an embodiment, the engine may be referred to as a reporting engine or an execution engine. The reports being based on the processed data stored in the reporting database (118). The widget library (122) is configured to retrieve processed data from the reporting database (118) and generate analytical reports in graphical and tabular form. The developer (120) links widgets to user requests and facilitates their integration into the user interface of either the external application (104) or an internal dashboard. Widgets may be configured to retrieve data in response to real-time user requests and apply associated processing logic prior to rendering the output.

The generated graphical and tabular reports can be embedded within the user interface of the external application (104) using pre-generated code such as HTML, JavaScript, or Cascading Style Sheets (CSS). In certain embodiments, the developer (120) packages the ingestion configuration, ETL pipeline, and widget logic into a deployable code module executable by the processor (107).

In one embodiment, a creation of the application (104) may be illustrated. In the embodiment, the developer 112 may create a data model. The analytics platform (102) may comprise a plurality of templates associated with various standard data models stored in a repository. In an embodiment, the data model is typically implemented as the reporting database. In a simple reporting database (118) implementation, each row of a table represents one instance of an entity type, and each field in a table represents an attribute type. In the reporting database (118), a relationship between entities is implemented by storing the primary key of one entity as a pointer or “foreign key” in the table of another entity.

Further, the data model may defines master reference data entities that are commonly used by the organization or enterprises. The developer may develop an enterprise-wide conceptual data model to support documenting the data architecture for an organization. The data model may be used as the foundation for one or more logical data models. The purpose of the data model is to establish structural metadata commonality for the master data entities between the set of logical data models.

The developer 112 may select and modify a template from the plurality of templates as per requirements. The requirements may be received from a client using a user device (101). In one embodiment, the developer 112 may be referred to as an application developer.

Further, the developer 112 may create multiple injection hooks or API in the analytics platform (102). The injection hooks or API may represents any customization point in the analytics platform (102). For example, there may be some small code to clean the data after ingestion or at some point in the ETL pipeline. Once the data pipeline is created, the developer may choose a point in the ETL pipeline and write custom code to modify the data at that stage.

Various mechanisms may be used to add the data required for analytics to the analytics platform (102). In one embodiment, the developer 112 may create data transformation logic inside the analytics platform (102). In the embodiment, different ways for summarizing, aggregating, slicing, augmentation, and the like, of the data may be utilized.

In one embodiment, the analytics platform (102) is implemented as a system (100). The system (100) hosts and manages the execution of these pipelines while ensuring strict data segregation, such that data associated with one analyst (110) is inaccessible to other analysts. This segregation is achieved by instantiating a separate ETL pipeline for each node, with no shared data paths or intermediate storage between pipelines. Data handling within each pipeline is fully automated, with data flowing through a sequence of connected processing nodes that execute predefined or custom operations in accordance with tenant-specific analytical requirements.

The platform further includes developer tools (120) for pipeline creation and customization. These tools provide a graphical or programmatic interface to define processing nodes, specify node connections, and assign data processing logic such as transformation, summarization, aggregation, slicing, augmentation, and state lookups. In one embodiment, the developer tools (120) incorporate artificial intelligence capabilities capable of generating an entire ETL pipeline configuration from a high-level textual or structured description of the desired analytics. This enables rapid deployment without requiring extensive manual configuration. Additionally, the platform includes a library of pre-built widgets and processing stages, which developers can use directly rather than implementing such components from scratch.

Within an ETL pipeline, each node performs a distinct processing step and may operate as a data ingestion node, a transformation node, an output node, or a storage node. Ingestion nodes are triggered by incoming data from external systems, initiating the processing workflow. Transformation nodes apply data modifications, aggregations, or filtering, and may query or update an internal database. Output nodes deliver processed data to external systems, such as by sending emails, displaying on-screen visualizations, or exporting to external files. Storage nodes persist processed datasets within the internal database, which may later be queried by widgets or used to generate detailed reports. Widgets process user queries in real time, retrieve relevant data, and return results with presentation logic in formats such as HTML, CSS, or JavaScript. Detailed reports, in contrast, return larger datasets in tabular form for in-depth analysis or long-term archival, such as a complete listing of all messages delivered during a billing cycle. The ETL pipeline's node-based design allows flexible communication between stages, with node connections explicitly defining the routing of outputs from one node to one or more downstream nodes.

Each processing step in the ETL pipeline is basic a program in some programming language. As per one example, the system may use HBase which allow running SQL commands on data that resides in files. In such cases, the ETL pipeline is essentially a bunch of SQL commands together with a framework on HBase. So at periodic intervals, the commands get executed. This may constitutes the ETL pipeline.

In one embodiment, the developer 112 may define the format in which the data ready for reporting and analytics is stored. It may be raw files in standard relational databases in Online Analytical Processing (OLAP) stores or other custom purpose databases.

The developer 112 may define multiple queries and associated widgets that may be used to generate reports and dashboards. Further, the developer 112 may collect all the codes generated from designing of the ingestion hooks or API's to defining of widgets, packages them and deploys them on the platform. The analytics platform (102) may be a group of execution engines. Each one of the execution engines may require programs in separate languages. An orchestration layer of the ETL pipeline. The orchestration layer may call the other components at the correct times. As per one embodiment, when the platform is used for a use case, programs for a number of components need to be developed. Ultimately, all these programs need to be collected at one point and packaged in a particular format so that the platform may understand and execute them correctly.

In one embodiment, the developer 112 may modify the application (104) to push the data to the analytics platform (102) via the injection hooks or API. Further, the developer 112 may add the widget in a user interface of the application (104) or supporting internal dashboards. The modification may involve following certain authentication convention (that are part of the inventive design) to allow seamless authentication and authorization of the analyst (110) who will use the reports for further processing.

In one embodiment, the ingestion of the data is explained further. As the application (104) runs, the application may generate various data or events and pushes the generated data or events relevant for analytics to the analytics platform (102) via the injection hooks or API's. Further, the analytics platform (102) may aggregates or transforms the data as per the logic. The transformation may run in real time or in batch mode, and the same may be modified and controlled after the package has been deployed. The package may corresponds to code or algorithm comprising steps from designing of ingestion hooks or API's till defining of the widgets. Furthermore, the analytics platform (102) may update the reports in real time or in batch mode based on the incoming data.

In an example use case, users transmit messages through the system (100), and billing is based on the number of messages delivered for each vendor. For an end-of-month billing model, the analytics pipeline may operate in batch mode, executing once per month to generate the vendor-wise delivery report. Alternatively, for a wallet-based or prepaid model, the pipeline may run in real time, processing each delivery event immediately to enable instant balance deduction. The same pipeline architecture supports both modes, with batch execution frequency configurable as required.

In one embodiment, the displaying of the reports may be explained further. In the embodiment, the analyst (110) may navigate to the user interface of the application (104) and a browser or application (104) makes a call to the analytics platform (102). The widgets of the analytics platform (102) may use the platform convention to add authenticated data to the call and the same is verified by the analytics platform (102). The analytics platform (102) may run the queries and returns the data as per the widget format. The data may be rendered on the widget as a user interface component (i.e., graphs, charts, and the like.) or detailed reports.

In one embodiment, the detailed reports function similarly to widgets but are designed to return larger datasets, typically in tabular form, intended for in-depth analysis or long-term archival rather than immediate visual consumption. As per one example, the detailed report may list all messages delivered within a given period, enabling downstream processes such as invoice reconciliation in scenarios where charges are applied per delivered message. In another embodiment, the summary reports provide aggregated metrics, such as the total number of messages delivered, and may include sufficient granularity to support graphical visualizations. As per another example, delivered message counts may be broken down by day and represented as a line chart or as a cumulative buildup graph showing the total from the start of the month to date.

In one embodiment, the operations stage of the analytics platform (102) corresponds directly to the execution of the ETL pipeline. Incoming data is received via the input or ingestion mechanisms, processed through a sequence of transformation, aggregation, summarization, slicing, or augmentation nodes, and ultimately made available as outputs in the form of widgets or detailed reports. This stage follows a conventional ETL process flow and the platform's ability to support multiple tenants concurrently. Each node is assigned a dedicated ETL pipeline, allowing multiple pipelines. Each ETL pipeline may potentially differ in structure, processing logic, and configuration. Each ETL pipeline executes in parallel while maintaining strict data segregation and operational independence.

In one embodiment, the platform enables users to configure the ETL pipeline in a Software-as-a-Service (SaaS) environment. Traditionally, analytics solutions are tightly coupled with existing systems, making externalization or decoupling non-trivial. The disclosed architecture abstracts the pipeline definition and configuration at an optimal level, allowing for flexible integration without requiring deep modifications to source systems.

For transformation processing nodes, the platform provides a dual capability: standard pre-implemented processing logic for common use cases, and a mechanism for creating custom hooks or modifying the default implementations. This “mix and match” model achieves a balance between genericity and specificity that is uncommon in existing systems. Highly generic platforms, such as Hadoop or Metabase, typically require users to author substantial amounts of custom code and self-host the solution, increasing operational complexity. Conversely, specialized platforms such as Google Analytics or Mixpanel are often optimized for narrow use cases, sacrificing adaptability. The analytics platform (102) uniquely supports both extensibility and broad applicability within a unified hosted framework.

Additionally, the setup stage incorporates an AI-assisted configuration mechanism. This component is capable of interpreting high-level analytics requirements expressed in natural language or structured form, mapping them to abstract ETL pipeline concepts, and automatically generating the corresponding pipeline configuration. This capability reduces the technical overhead for end users, enabling rapid deployment of sophisticated analytics pipelines without requiring in-depth ETL development expertise.

In one illustrative example, a hypothetical customer operates a message delivery platform and utilizes the analytics platform (102) to generate delivery reports and perform billing for their own customers. The ETL pipeline for this use case comprises multiple nodes organized into input, transformation, and output stages. In the input stage, a Submit node is triggered whenever a message is sent to an SMS operator, with the customer's system invoking an API call to transmit the submit event to the analytics platform (102). Similarly, a Deliver node is triggered when the SMS operator confirms message delivery, with the delivery event also sent via API integration.

Within the transformation stage, an augmentation node associates each submit event with its corresponding delivery event based on a unique request ID generated by the SMS operator. A subsequent transformation node computes the status for each submit request, categorizing it as IN_PROGRESS, DELIVERED, or FAILED. In the output stage, a detailed report is generated containing one record per submit request, including all fields from the submit and delivery events along with the computed status. Additionally, a delivery graph widget plots the number of messages delivered per hour, and an MTD (Month-to-Date) delivery report provides a real-time aggregate count of all messages delivered in the current month. The analytics platform (102) further generates embeddable HTML and JavaScript code for these outputs, enabling the customer to integrate the delivery graph, the MTD delivery card, and a downloadable detailed report directly into their website for real-time visibility and customer access.

Some embodiments of the present subject matter configures an analytics platform (102) to build an analytics pipeline and configures an application (104) to work with the analytics platform (102).

Some embodiments of the present subject matter allows seamless authentication and authorization of reports to analysts (110).

Some embodiments of the present subject matter provides defining of an individual ETL pipelines, process and store of data as per client requirements and provide a unified interface at the query level.

The present invention discloses a system a system (100) for providing an analytics platform (102), the system comprising a user device (101) configured to receive a plurality of user requests, wherein each user request comprises a query and an input data, a reporting database (118) operably coupled to a processor, the reporting database (118) configured to store the query and the input data, a processor (107) coupled with a memory (103) configured for storing the reporting database (118), a plurality of modules executable by the processor (107). The plurality of modules comprising an ingestion module (114) configured to receive the plurality of user requests from the user device (101) or an external application (104) through one or more defined application programming interfaces (APIs). An Extract-Transform-Load (ETL) module (116) configured to generate an Extract-Transform-Load (ETL) pipeline for each user request the ETL pipeline comprising a plurality of pipeline nodes connected according to configuration data defined through a developer interface (120) and perform a plurality of a processing operations on the input data at each of the pipeline nodes, the processing operation comprising at least one of a transformation, summarization, aggregation, slicing, and augmentation, configure each pipeline node to receive data from one or more upstream nodes, process that data, and provide processed data to one or more downstream nodes, store, at one or more designated nodes, the processed data in the reporting database (118), and automatically generate and execute the ETL pipeline based on a high-level analytical requirements of the user request, a plurality of widget libraries configured to query the reporting database (118), and retrieve processed data associated with the plurality of user requests, and an engine, executable by the processor, configured to generate graphical and tabular reports by invoking widgets from the widget libraries (122), the reports being based on the processed data stored in the reporting database (118), wherein a separate ETL pipeline is instantiated and executed for each user request thereby providing data segregation and secure operation.

In another embodiment, the ingestion module (114) receives input data from the user device (101) or external application (104) and forwards said input data to the ETL module (116), the ETL module (116) processes and stores the data in the reporting database (118), the widget libraries (122) retrieve the processed data from the reporting database (118), and the engine generates reports by invoking the widget libraries (122).

In another embodiment, the developer interface (120) is configured to provide a plurality of pre-defined ETL pipeline templates, wherein the plurality of pre-defined ETL pipeline templates is selected and modified by a developer (112) based on the user request.

In another embodiment, the ingestion module (114) is configured to provide real-time data ingestion based on the nature of the user request.

In another embodiment, each pipeline node in the ETL module (116) is associated with a specific operation defined by configuration data, the operation comprising at least one of a data transformation, a data validation, a data join, or a data enrichment step.

In another embodiment, the pipeline nodes are dynamically instantiated based on the analytical requirements of the user request, such that only the required nodes are activated within the ETL pipeline.

In another embodiment, each pipeline node is assigned a unique identifier to enable tracking of data flow and logging of results at each stage of the ETL pipeline.

In another embodiment, one or more pipeline nodes are designated as storage nodes configured to commit processed data to the reporting database (118), while other pipeline nodes serve as intermediate nodes configured to pass data further downstream for additional processing without storing results.

In another embodiment, each pipeline node is further configured with metadata defining node type, processing method, and expected input and output schema.

In another embodiment, each ETL pipeline instantiated for a user request is executed in an isolated runtime environment selected from at least one of: a separate execution thread, a containerized process, or a virtual machine instance, thereby preventing data leakage or interference between multiple user requests.

In another embodiment, the developer interface (120) is configured to integrate the widget into a user interface of the external application (104) or an internal dashboard.

In another embodiment, the widget is configured to retrieve processed data from the reporting database (118) in response to a real-time user request, and to apply formatting logic to the retrieved data prior to generating the graphical and tabular reports.

In another embodiment, the graphical and tabular reports are configured to be embedded within a user interface of the external application (104) via pre-generated code including HTML, JavaScript, or Cascading Style Sheets (CSS).

In another embodiment, the developer interface (120) is configured to package the ingestion configuration, ETL pipeline, and widget logic into a deployable code module for execution by the processor (107).

In another embodiment, the transformation processing step is configured to convert input data format into normalized values and derive new data fields using transformation logic.

In another embodiment, the summarization processing step is configured to generate statistical summaries of input data, the statistical summaries comprising at least one of: a count, average, minimum, and maximum values over a defined time window or group.

In another embodiment, the aggregation processing step is configured to combine multiple records into a single output record using an aggregation rule, the aggregation rule being defined through the developer interface (120).

In another embodiment, the slicing processing step is configured to filter and separate incoming data based on predefined conditions, the predefined conditions being selected from at least one of: date, category, or user segment, and defined through the developer interface (120).

In another embodiment, the developer interface (120) is configured to define the connection between each pipeline node and to assign data processing logic to each node.

In another embodiment, the ETL Module (116) is configured to simultaneously execute a plurality of pipeline nodes in the absence of a direct data dependency between said pipeline nodes, thereby improving processing efficiency.

In another embodiment, a method for operating an analytics platform (102), the method comprising receiving, at an ingestion module (114), a plurality of user requests from a user device (101) or an external application (104), each user request comprising a query and input data, the user requests being received through one or more defined application programming interfaces (APIs), generating, by an Extract-Transform-Load (ETL) module (116), an ETL pipeline for each user request, the ETL pipeline comprising a plurality of pipeline nodes connected according to configuration data defined using a developer interface (120), executing processing operations on the input data at each of the plurality of pipeline nodes, each processing operation comprising at least one of transformation, summarization, aggregation, slicing, or augmentation, configuring each pipeline node to receive data from one or more upstream nodes, process that data, and provide processed data to one or more downstream nodes, storing, at one or more designated pipeline nodes, processed data in a reporting database (118), automatically generating and executing the ETL pipeline based on high-level analytical requirements defined in the user request, retrieving, using one or more widget libraries (122), the processed data associated with the plurality of user requests from the reporting database (118), and generating, by an engine, graphical and/or tabular reports based on the processed data and by invoking widgets from the widget libraries (122), wherein a separate ETL pipeline is instantiated and executed for each user request, thereby providing data segregation and secure operation.

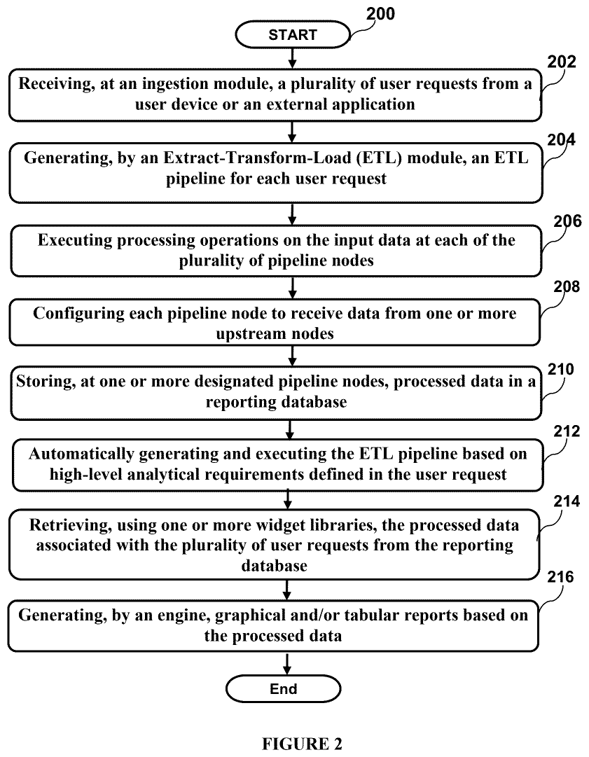

FIG. 2 illustrates a flow chart performing a method (200) for operating an analytics platform (102), in accordance with an embodiment of the present subject matter. The order in which the method (200) is described is not intended to be construed as a limitation, and any number of the described method blocks may be combined in any order to implement the method (200) or alternate methods. Additionally, individual blocks may be deleted from the method (200) without departing from the spirit and scope of the subject matter described herein. Furthermore, the method may be implemented in any suitable hardware, software, firmware, or combination thereof. However, for ease of explanation, in the embodiments described below, the method (200) may be considered to be implemented as described in the system (100).

At block (202), receiving, at an ingestion module (114), a plurality of user requests from a user device (101) or an external application (104). In one implementation, each user request comprising a query and input data, the user requests being received through one or more defined application programming interfaces (APIs).

At block (204), generating, by an Extract-Transform-Load (ETL) module (116), an ETL pipeline for each user request. In one implementation, the ETL pipeline comprising a plurality of pipeline nodes connected according to configuration data defined using a developer interface (120).

At block (206), executing processing operations on the input data at each of the plurality of pipeline nodes. In one implementation, each processing operation comprising at least one of transformation, summarization, aggregation, slicing, or augmentation.

At block (208), configuring each pipeline node to receive data from one or more upstream nodes, process that data, and provide processed data to one or more downstream nodes.

At block (210), storing, at one or more designated pipeline nodes, processed data in a reporting database (118).

At block (212), automatically generating and executing the ETL pipeline based on high-level analytical requirements defined in the user request.

At block (214), retrieving, using one or more widget libraries (122), the processed data associated with the plurality of user requests from the reporting database (118).

At block (216), generating, by an engine, graphical and/or tabular reports based on the processed data and by invoking widgets from the widget libraries (122), wherein a separate ETL pipeline is instantiated and executed for each user request, thereby providing data segregation and secure operation.

The method for operating the analytics platform (102) comprises receiving a plurality of user requests via the user device (101), storing the associated queries and input data in the reporting database (118), and processing them through the ingestion module (114) using the plurality of injection hooks or API. For each user request, the method further comprises creating an ETL pipeline using the developer (120), executing the defined processing steps across multiple pipeline nodes, storing the processed data in the reporting database (118), retrieving the processed data via the widget library (122), and generating graphical or tabular reports for display to the end user. A separate ETL pipeline is instantiated for each user request to ensure data segregation and secure operation.

By implementing the disclosed system (100) and method, the present disclosure provides a highly customizable, developer-driven analytics environment that supports secure, segregated, and efficient data processing while offering real-time and batch analytics capabilities. The system (100) may enable enterprises to deploy advanced reporting and visualization tools without sacrificing modularity, security, or performance.

With respect to the use of substantially any plural and/or singular terms herein, those having skill in the art can translate from the plural to the singular and/or from the singular to the plural as is appropriate to the context and/or application (104). The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.

1. A system (100) for providing an analytics platform (102), the system comprising:
a user device (101) configured to receive a plurality of user requests, wherein each user request comprises a query and an input data;
a reporting database (118) operably coupled to a processor, the reporting database (118) configured to store the query and the input data;
a processor (107) coupled with a memory (103) configured for storing the reporting database (118);
a plurality of modules executable by the processor (107), the plurality of modules comprising:
an ingestion module (114) configured to receive the plurality of user requests from the user device (101) or an external application (104) through one or more defined application programming interfaces (APIs);
an Extract-Transform-Load (ETL) module (116) configured to:
generate an Extract-Transform-Load (ETL) pipeline for each user request the ETL pipeline comprising a plurality of pipeline nodes connected according to configuration data defined through a developer interface (120); and
perform a plurality of a processing operations on the input data at each of the pipeline nodes, the processing operation comprising at least one of a transformation, summarization, aggregation, slicing, and augmentation;
configure each pipeline node to receive data from one or more upstream nodes, process that data, and provide processed data to one or more downstream nodes;
store, one or more designated nodes, the processed data in the reporting database (118); and
automatically generate and execute the ETL pipeline based on a high-level analytical requirements of the user request;
a plurality of widget libraries configured to query the reporting database (118), and retrieve processed data associated with the plurality of user requests; and
an engine, executable by the processor, configured to generate graphical and tabular reports by invoking widgets from the widget libraries (122), the reports being based on the processed data stored in the reporting database (118);
wherein a separate ETL pipeline is instantiated and executed for each user request thereby providing data segregation and secure operation.

2. The system (100) as claimed in claim 1, wherein the ingestion module (114) receives input data from the user device (101) or external application (104) and forwards said input data to the ETL module (116), the ETL module (116) processes and stores the data in the reporting database (118), the widget libraries (122) retrieve the processed data from the reporting database (118), and the engine generates reports by invoking the widget libraries (122).

3. The system (100) as claimed in claim 1, wherein the developer interface (120) is configured to provide a plurality of pre-defined ETL pipeline templates, wherein the plurality of pre-defined ETL pipeline templates is selected and modified by a developer (112) based on the user request.

4. The system (100) as claimed in claim 1, wherein the ingestion module (114) is configured to provide real-time data ingestion based on the nature of the user request.

5. The system (100) of claim 1, wherein each pipeline node in the ETL module (116) is associated with a specific operation defined by configuration data, the operation comprising at least one of a data transformation, a data validation, a data join, or a data enrichment step.

6. The system (100) of claim 1, wherein pipeline nodes are dynamically instantiated based on the analytical requirements of the user request, such that only the required nodes are activated within the ETL pipeline.

7. The system (100) of claim 1, wherein each pipeline node is assigned a unique identifier to enable tracking of data flow and logging of results at each stage of the ETL pipeline.

8. The system (100) of claim 1, wherein one or more pipeline nodes are designated as storage nodes configured to commit processed data to the reporting database (118), while other pipeline nodes serve as intermediate nodes configured to pass data further downstream for additional processing without storing results.

9. The system (100) of claim 1, wherein each pipeline node is further configured with metadata defining node type, processing method, and expected input and output schema.

10. The system (100) of claim 1, wherein each ETL pipeline instantiated for a user request is executed in an isolated runtime environment selected from at least one of: a separate execution thread, a containerized process, or a virtual machine instance, thereby preventing data leakage or interference between multiple user requests.

11. The system (100) of claim 1, wherein the developer interface (120) is configured to integrate the widget into a user interface of the external application (104) or an internal dashboard.

12. The system (100) as claimed in claim 1, wherein the widget is configured to retrieve processed data from the reporting database (118) in response to a real-time user request, and to apply formatting logic to the retrieved data prior to generating the graphical and tabular reports.

13. The system (100) as claimed in claim 1, wherein the graphical and tabular reports are configured to be embedded within a user interface of the external application (104) via pre-generated code including HTML, JavaScript, or Cascading Style Sheets (CSS).

14. The system (100) as claimed in claim 1, wherein the developer interface (120) is configured to package the ingestion configuration, ETL pipeline, and widget logic into a deployable code module for execution by the processor (107).

15. The system (100) as claimed in claim 1, wherein the transformation processing step is configured to convert input data format into normalized values and derive new data fields using transformation logic.

16. The system (100) as claimed in claim 1, wherein the summarization processing step is configured to generate statistical summaries of input data, the statistical summaries comprising at least one of: a count, average, minimum, and maximum values over a defined time window or group.

17. The system (100) as claimed in claim 1, wherein the aggregation processing step is configured to combine multiple records into a single output record using an aggregation rule, the aggregation rule being defined through the developer interface (120).

18. The system (100) as claimed in claim 1, wherein the slicing processing step is configured to filter and separate incoming data based on predefined conditions, the predefined conditions being selected from at least one of: date, category, or user segment, and defined through the developer interface (120).

19. The system (100) as claimed in claim 1, wherein the developer interface (120) is configured to define the connection between each pipeline node and to assign data processing logic to each node.

20. The system (100) as claimed in claim 1, wherein the ETL Module (116) is configured to simultaneously execute a plurality of pipeline nodes in the absence of a direct data dependency between said pipeline nodes, thereby improving processing efficiency.

21. A method for operating an analytics platform (102), the method comprising:
receiving, at an ingestion module (114), a plurality of user requests from a user device (101) or an external application (104), each user request comprising a query and input data, the user requests being received through one or more defined application programming interfaces (APIs);
generating, by an Extract-Transform-Load (ETL) module (116), an ETL pipeline for each user request, the ETL pipeline comprising a plurality of pipeline nodes connected according to configuration data defined using a developer interface (120);
executing processing operations on the input data at each of the plurality of pipeline nodes, each processing operation comprising at least one of transformation, summarization, aggregation, slicing, or augmentation;
configuring each pipeline node to receive data from one or more upstream nodes, process that data, and provide processed data to one or more downstream nodes;
storing, at one or more designated pipeline nodes, processed data in a reporting database (118);
automatically generating and executing the ETL pipeline based on high-level analytical requirements defined in the user request;
retrieving, using one or more widget libraries (122), the processed data associated with the plurality of user requests from the reporting database (118); and
generating, by an engine, graphical and/or tabular reports based on the processed data and by invoking widgets from the widget libraries (122);
wherein a separate ETL pipeline is instantiated and executed for each user request, thereby providing data segregation and secure operation.
